(19) United States
(12) Patent Application Publication
(10) Pub. No.: US 2012/0102439 A1
(43) Pub. Date: Apr. 26, 2012

(54) SYSTEM AND METHOD OF MODIFYING THE DISPLAY CONTENT BASED ON SENSOR INPUT

(76) Inventors: April Slayden Mitchell, San Jose, CA (US); Ian N. Robinson, Pebbles Beach, CA (US); Mark C. Solomon, San Jose, CA (US)

(21) Appl. No.: 13/223,130

(22) Filed: Aug. 31, 2011

Related U.S. Application Data
(63) Continuation-in-part of application No. 12/915,311, filed on Oct. 29, 2010.
Application No. 12/915,311 is a continuation-in-part of application No. PCT/US2010/053860, filed on Oct. 22, 2010.

(51) Int. Cl. G06F 3/033

(52) U.S. Cl. 715/863

(57) ABSTRACT

A display system comprised of: a display including a display screen configured to operate in at least a transparent display mode; an interaction sensing component for receiving sensed data regarding physical user interactions; and an interaction display control component, wherein responsive to the sensed data meeting predefined interaction criteria, content on the display screen is modified.

### CROSS-REFERENCE TO RELATED APPLICATIONS

This case is a continuation in part of the case entitled “Display System and Method of Displaying Based on Device Interactions” filed on Oct. 29, 2010, having Ser. No. 12/915,311, which is hereby incorporated by reference in its entirety. In addition this case is related to the case entitled “An Augmented Reality Display System and Method of Display” filed on Oct. 22, 2010, having serial number PCT/US2010/053860 and the case entitled “Display System and Method of Displaying Based on Device Interactions” filed on Oct. 29, 2010, having Ser. No. 12/915,311, both cases which are hereby incorporated by reference in their entirety.

### BACKGROUND

A wide variety of displays for computer systems are available. Often display systems display content on an opaque background screen. However, systems are available which display content on a transparent background screen.

### BRIEF DESCRIPTION OF DRAWINGS

The figures depict implementations/embodiments of the invention and not the invention itself. Some embodiments are described, by way of example, with respect to the following Figures.

FIG. 1 illustrates a block diagram of a front perspective view of a display screen in an display system for modifying the display content based on sensor input according to an example of the invention;

FIG. 2A shows a side view of a desktop version of the display system shown in FIG. 1 where a keyboard is docked underneath the display screen according to an example of the invention;

FIG. 2B shows a side view of a desktop version of the display system shown in FIG. 2A after the keyboard underneath the display screen has been removed from behind the display according to an example of the invention;

FIG. 2C shows a front perspective view of the display screen of the shown in FIG. 2B according to an example of the invention;

FIG. 3A shows a front perspective view of a desktop version of the content on a display screen after the user's hands are positioned underneath the display according to an example of the invention;

FIG. 3B shows a side perspective view of the content on the display screen of the display system shown in FIG. 3A after the user's hands are positioned underneath the thru screen display screen according to an example of the invention;

FIG. 4A shows a front perspective view of a desktop version of the display system shown in FIG. 1 where the user's hands position a camera behind the display screen according to an example of the invention;

FIG. 4B shows a side perspective view of the display system shown in FIG. 4A where a camera is positioned behind the display screen according to an example of the invention;

FIG. 4C shows a front perspective view of the display system shown in FIG. 4B where a menu appears when a camera is positioned behind the display screen according to an example of the invention;

FIG. 5A shows a front perspective view of a desktop version of the display system shown in FIG. 1 where two cameras are positioned behind the display screen according to an example of the invention;

FIG. 5B shows a side perspective view of the display system shown in FIG. 5A according to an example of the invention;

FIG. 6 shows a flow diagram for a method of modifying the display content according to an example of the invention;

FIG. 7 shows a computer system for implementing the method shown in FIG. 6 and described in accordance with examples of the present invention.

The drawings referred to in this Brief Description should not be understood as being drawn to scale unless specifically noted.

### DETAILED DESCRIPTION OF THE EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

For a display screen capable of operating in at least a transparent mode, sensors may be added to the display system that increase the number of possible ways that a user can interact with the display system. There are many different ways that a user of a thru-screen display system can (1) move the display screen or alternatively (2) move an object (including the user's hands, electronic device, etc.) with respect to the display screen. When a user moves the display screen from one position to another for example, this could trigger an event which may cause a change in the user interface displayed such as the appearance of a new control that wasn't previously there. Similarly, if a user removes an object that is behind (or underneath) the thru-screen display, an option to show a virtual representation of a keyboard or a virtual representation may automatically appear. Having sensors which can detect these changes and notify the display system can automate these tasks and remove complexity from the user interface.

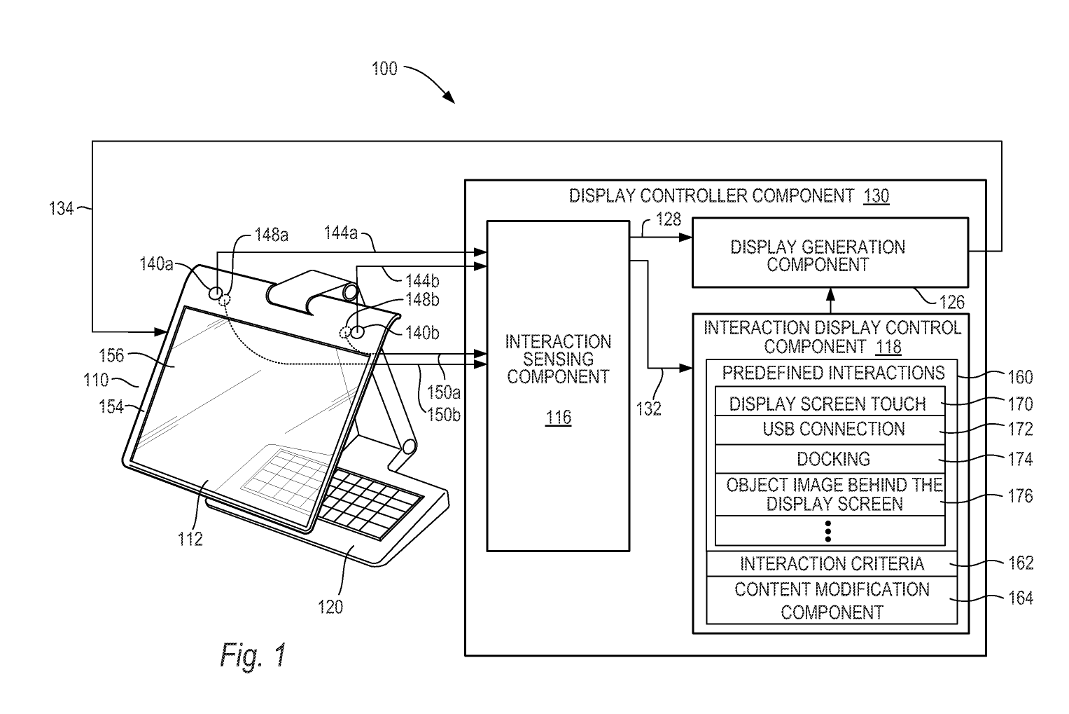

The present invention describes a method and system capable of automatically modifying the content displayed based on sensor input based on a current or past physical action. FIG. 1 illustrates a block diagram of a display system including a front view of the display screen. The display system 100 is comprised of: a display 110, including a display screen 112 configured to operate in at least a transparent mode; an interaction sensing component for receiving information regarding sensed physical user interactions and an interaction display control component 118 wherein responsive to sensed predefined physical interactions meeting predefined interaction criteria the content on the display screen 112 is modified.

One benefit of the described embodiments is that content presented on the thru screen display is controlled automatically in reaction to the user's sensed physical interactions. This is in contrast to some systems where the user controls the displayed content manually by using user interfaces (i.e. a menu, etc.) to perform a selection. In one example, the sensed physical interactions do not include selections by the user via user interfaces.

In some cases, the user's physical interactions are with an interfacing object. An example of an interfacing object would be for example, the user's hands. An alternative example of an interfacing object might be a device such as a camera or keyboard. The content that is displayed on the display screen is due to the sensed physical event.

Referring to FIG. 1, shows a display that is capable of operating in at least a transparent mode. In one example, the display 110 includes a display screen 112 that is comprised of a transparent screen material that has a front surface 154 and a rear surface 158. Although alternative materials and implementations are possible, the transparent display screen operates so that interfacing device 120 positioned behind the display screen 112 can be easily seen or viewed by a user 122 (not shown) positioned in front of the display screen 112. The transparent display screen allows the user 122 to have a clear view of the device 120 (or devices) behind the screen that are being manipulated in real time and to instantaneously see the effect of their manipulation on the display 112. The user can interact with the interfacing objects 120 and the display 112 to perform operations in an intuitive manner.

The sensing system in the thru screen can be a combination of hardware-based sensing (including hinge closure sensors, base/monitor position, and keyboard docking) as well as software-based sensing (such as through image analysis of the video stream from the front and rear facing cameras.) In one example, the display system shown in FIG. 1 may include a plurality of one type of sensor. In one example, the display system may include a plurality of sensors, where the plurality of sensors include different types of sensors. In one example, the type of sensors that can be used in the display system can include, but is not limited to: cameras or other image capture devices, touch sensors located on the back or front of the display screen, a current sensing device for monitoring the opening or closing of a hinge, etc.), a gyroscope for determining the position or change in position of a display system element or an object or device within the sensor range.

In addition, the display system also includes a display generation component 126, wherein based on data 128 from the interaction sensing component 116, the display generation component 126 creates content for the display on the display screen 112. The display controller component 130 outputs data 134 from at least the display generation component 126 to the display screen 112. Data (144a, 144b, 150a, 150b) is used by the display generation component 126 to generate content on the display screen. In one example, the displayed content is a visual representation of a physical object that it is replacing where the physical object was previously positioned behind the display screen. In one example, this replacement display content, could for example be displayed on display screen operating in either a transparent or opaque background. In one example, where the display screen 112 is operating in a transparent mode, the display content may be spatially aligned with the object 120 placed behind the display screen.

The display system 100 includes an interaction display control component 118. The interaction display control component 118 is capable of receiving data from the interaction sensors regarding physical interactions by a user, where the interaction sensors are either part of the display system or information from interaction sensors can be communicated to the display system controller component. Based on the collected sensor data, the interaction display control component 118 can determine if the interaction meets the predefined interaction criteria 160. If the predefined interactions meet the interaction criteria 162, then content is modified according to the content modification component 164. In one example, the modifications to the display content are changes to the content that occur when the display screen is powered on and visible to the user.

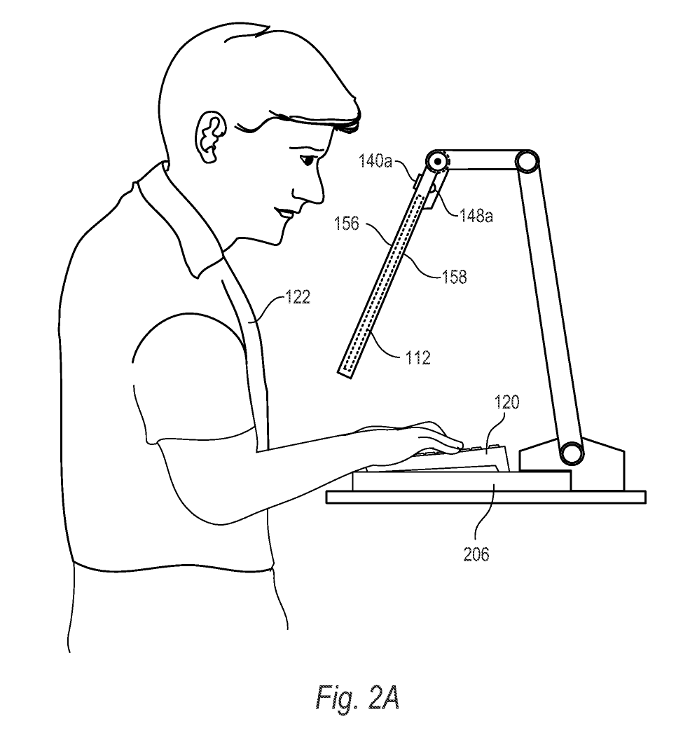

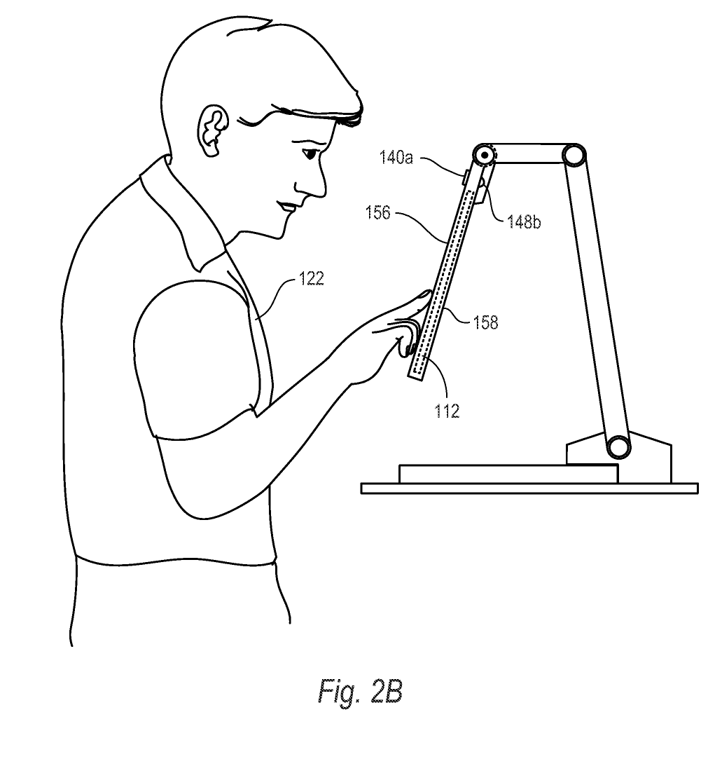

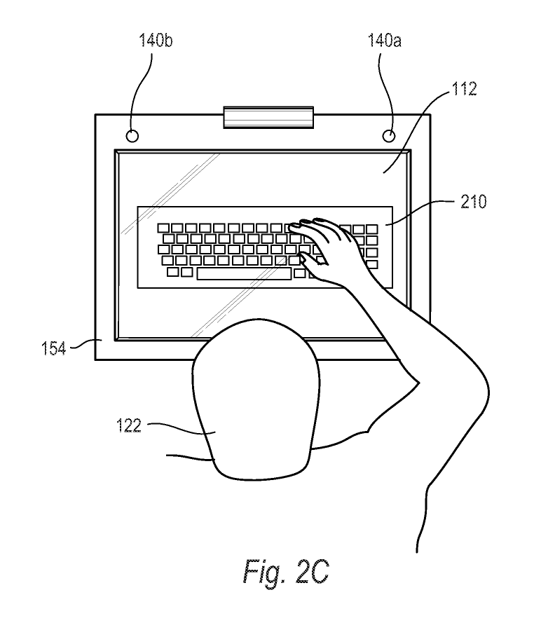

In one example, the interaction display control component 118 includes a predefined list of interactions 160. For example, in the example shown in FIGS. 2A-2C, the interaction that is sensed would be the removal of the keyboard from behind the display screen. The interaction criteria 162 might be whether the keyboard is completely removed from behind the thru-screen display and the resulting display content modification 164 would be the appearance of a virtual keyboard on the display screen. Information about the possible predefined interactions 116 and in some cases the type of interacting object or device 120 (i.e. keyboard) and the resulting display modification that results from the interaction are stored and used by the interaction display control component 118 and display generation component 126 to generate the displayed content.

The examples shown in FIGS. 2A-2C, 3A-3B, 4A-4C, 5A-5B show examples of different types of physical interactions or events that can be sensed by the sensors of the display system and the types of display modifications or reactions that can occur based on the sensed physical interactions. The types of physical interactions that can be sensed includes but is not limited to: the removal or insertion of a physical keyboard from a docking station, the removal or insertion of a USB device, the movement of a hinge in a display from an open to a closed position and vice versa, the sensing of an object positioned behind the screen, the sensing of a physical touch on the front or back of the display screen, etc.

FIG. 2A shows a side view of a desktop version of the display system shown in FIG. 1 where a keyboard is docked underneath the display screen according to an example of the invention. In the example shown in FIG. 2A, the display screen 112 is operating in a transparent background mode so that the user typing can see the keyboard 120 placed underneath the display screen as they type. The keyboard 120 is docked to a docking station 206. FIG. 2B shows a side view of the system shown in FIG. 2A after the keyboard underneath the display screen has been removed from the docking station 206 behind the display screen according to an example of the invention. In one example, sensors 140a, 148a, 140b, 148b in the display system can sense the removal of the keyboard (physical interaction) and based on sensed physical interaction (the removal of the keyboard from the docking station), the display is modified.

How the physical interaction is sensed depends on the type, number and location of the sensors available to the display system. For example, in one embodiment the physical removal of the keyboard from the docking station might be sensed by the change in current in a current sensor located in the docking station. When the sensed current reaches a certain predefined level according to the interaction criteria 162, then the system knows that the keyboard has been physically removed from the docking station. In another example, a camera or a plurality of cameras might be positioned in the vicinity of the display screen so that it can capture the area behind the display screen. The cameras (using image recognition software) can continuously monitor the area behind the display screen and when it senses that the camera is removed (predefined interaction), then the virtual keyboard will appear on the display screen. In another example, the keyboard includes an RFID label that label can be read by sensors (an RFID reader) when positioned behind the display screen that cannot be read when the keyboard is removed from behind the display screen. In another example, the keyboard could be plugged in via a USB plug and the unplugging of the USB plug could be sensed. In another example, the keyboard could be underneath the display screen being charged on an induction charging pad and a change in the electromagnetic field measurements could indicate that the keyboard was no longer plugged in and available for use.

In one example, instead of using a single type of sensor to confirm the interaction, different sensor types are used to determine whether the interaction conditions have been met. Take for example, the case where the keyboard is plugged in via a USB cable—but the keyboard is not located behind the display screen. If multiple sensor types exist, one type of sensor (i.e. current detector) might detect the USB connection and another type of sensor (i.e. camera) might detect that the keyboard is not under the display screen. For this case, in one example the display content might be changed to display a virtual keyboard. Alternatively for the same case, the display content might be changed to display a message instructing the user to “Move the keyboard underneath the display screen.”

Referring to FIG. 20 shows a front perspective view of the display screen of the shown in FIG. 2B according to an example of the invention. In the example shown, the predefined interaction is the sensing of the keyboard removal and the display modification that results when this occurs is the appearance of a virtual keyboard. After the removal of the physical keyboard, the user can interact with the virtual keyboard. In FIG. 2B, the physical keyboard has been removed and the user is shown interacting with/typing on the virtual keyboard.

In the example previously described, examples are given for the sensing a change in the keyboard position location. However, in an alternative embodiment, the sensors are not monitoring a change in status—they are monitoring the current status. For example, in this case the physical interaction being monitored is whether the user has or has not physically placed a keyboard behind the display screen. If a display screen is not behind the display screen, then a virtual keyboard is automatically generated on the display screen.

The automated reaction to the user's interaction (or failure to interact) reduces the need for additional user interactions. For example, instead of the user actively selecting from a series of menus the type of user interface that the user wants displayed on the display screen (for example, a virtual keyboard), the virtual keyboard automatically appears when a predefined physical user action (removal of the physical keyboard) occurs.

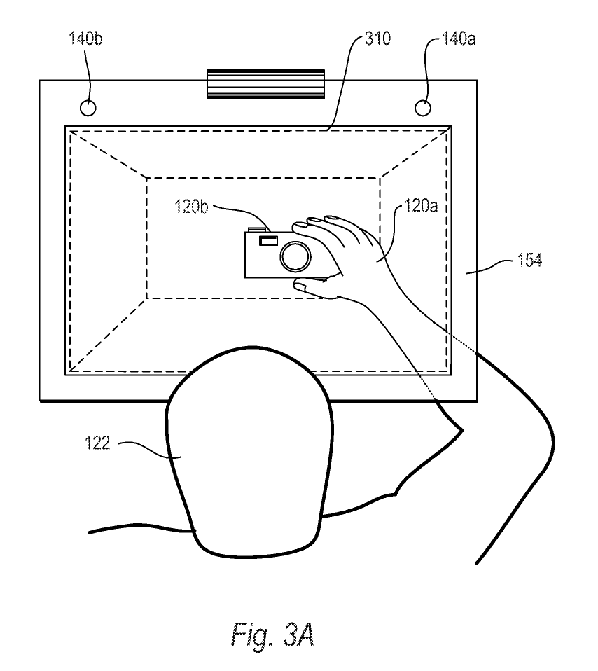

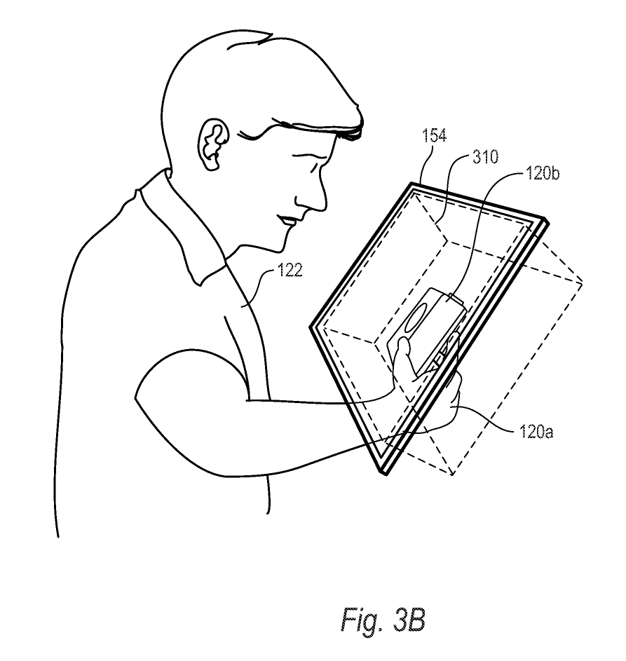

FIG. 3A shows a front perspective view of a desktop version of the content on a display screen after the user's hand 120a holding an object 120b (in this case a camera) is positioned underneath the display according to an example of the invention. FIG. 3B shows a side perspective view of FIG. 3B. Referring to FIGS. 3A and 3B shows an example where the display screen is operating in the transparent display screen mode with a transparent background.

FIG. 3A shows an example after the user has already positioned her hand behind the transparent display screen. Sensors recognize that the user's hands and/or camera have entered the volume behind the display screen. In response to sensing the user's hand and/or camera in the space behind the display screen, a user interface (a bounding box 310 for indicating the volume behind the screen in which the system can track the user's hands) is displayed on the display screen. This user interface is useful in that it gives the user feedback as to whether her hand or object held in her hand is being tracked by the display system.

In one example, the sensor used to determine whether the user's hand holding a camera is behind the display screen is a camera or plurality of camera (not shown) physically located on the frame 154 of the display screen. The event or action which causes the user's hand/camera to be sensed is moving within the capture boundaries of the camera. In another example (where the back surface of the display screen is touch sensitive), the appearance of the bounding box 310 user interface is dependent upon sensing the user touching the back of touch sensitive display screen.

In one example, different user interfaces appear based on whether the user's hands are positioned in front of or behind the display screen surface. For example, the bounding box display might appear when a camera senses that the user's hands are behind the display screen. When the user removes her hands from behind the display screen, the camera or other image sensing device will recognize that user's hands are no longer behind the display screen. Responsive to sensing that the user's hands are not behind the display screen, user interface elements that are usable when the user can interact with or touch the front side of the display screen can automatically appear.

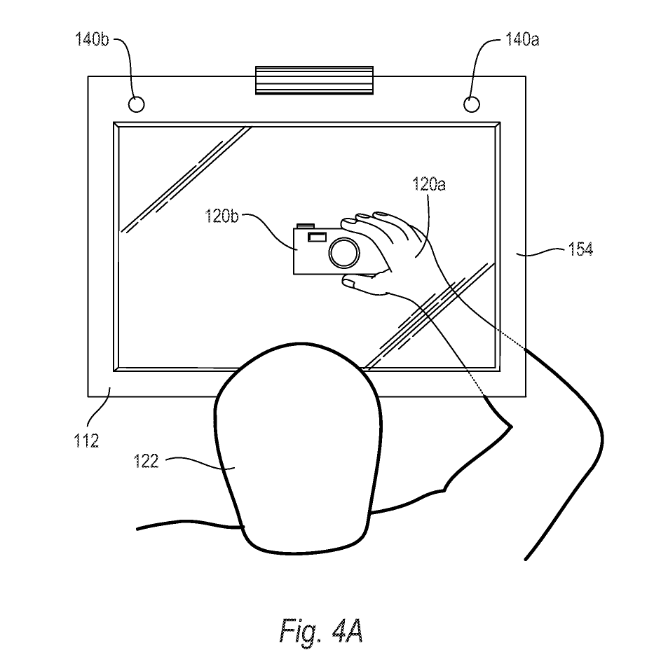

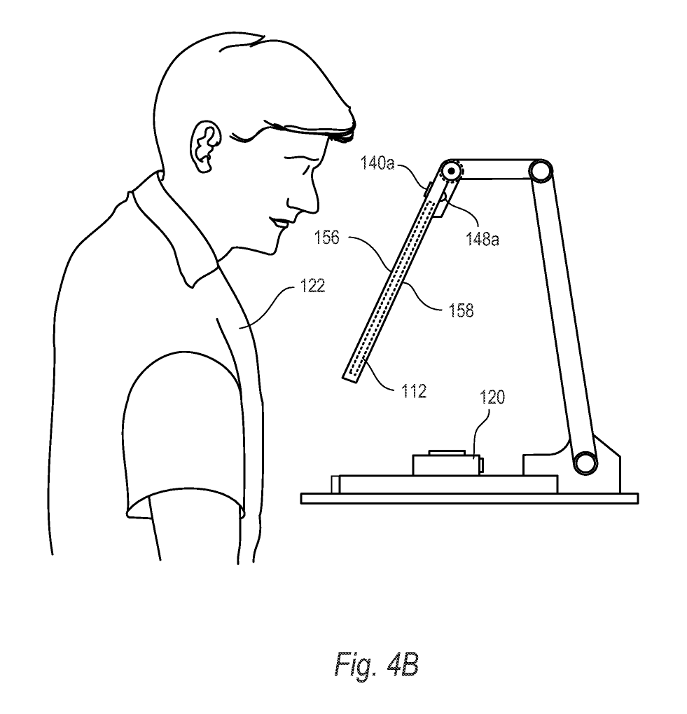

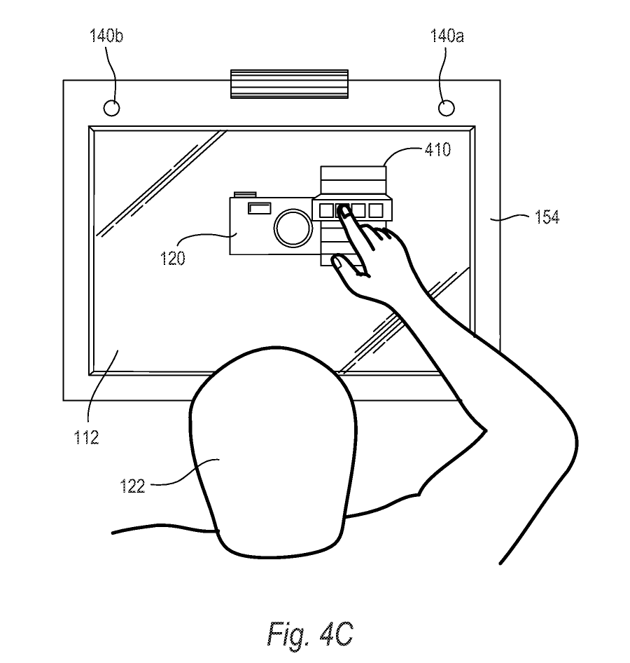

FIG. 4A shows a front perspective view of a desktop version of the display system shown in FIG. 1 where the user's hand 120a positions a camera 120b behind the display screen according to an example of the invention. FIG. 4B shows a side perspective view of the display system shown in FIG. 4A after the user has set the camera 120b onto the desk surface supporting the display. The display system can sense the presence of the camera 120b (or other object) behind the display screen and responsive to sensing the physical device, the display content is modified. In the example shown in FIG. 4A-4C, responsive to placing a camera behind the display screen—the display is automatically modified to display a menu 410 corresponding to the camera positioned behind the display screen. Referring to FIG. 4. FIG. 4C shows a front perspective view of the display system shown in FIG. 4B where a menu 410 corresponding to the camera—appears on the display screen.

As previously stated, the examples shown in FIGS. 2A-2C, 3A-3B, 4A-4C, 5A-5B show examples of different types of physical interactions or events that can be sensed by the sensors of the display system and the types of display modifications or reactions that can occur based on the sensed physical interactions. Specifically, the example shown in FIG. 4A-4C shows an event or interaction sensed with respect to an electronic device. Examples of different interactions with a various devices is described in detail in the application “Display System and Method of Displaying Based on Device Interactions” filed on Oct. 29, 2010, having Ser. No. 12/915,311. In this application, the display system 100 creates an “overlaid' image on the display screen 112—where the overlaid image is an image generated on the display screen that is between the user's viewpoint and the object 120 behind the screen on which it is “overlaid,” In one example, the overlaid image generated is dependent upon the user's viewpoint. Thus, the position of the overlaid image with respect to the object behind the display screen stays consistent even as the user moves their head and/or the object behind the display screen.

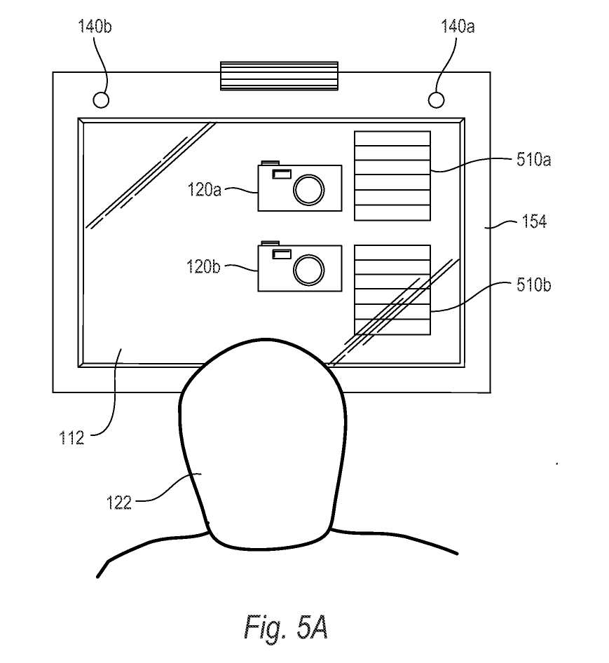

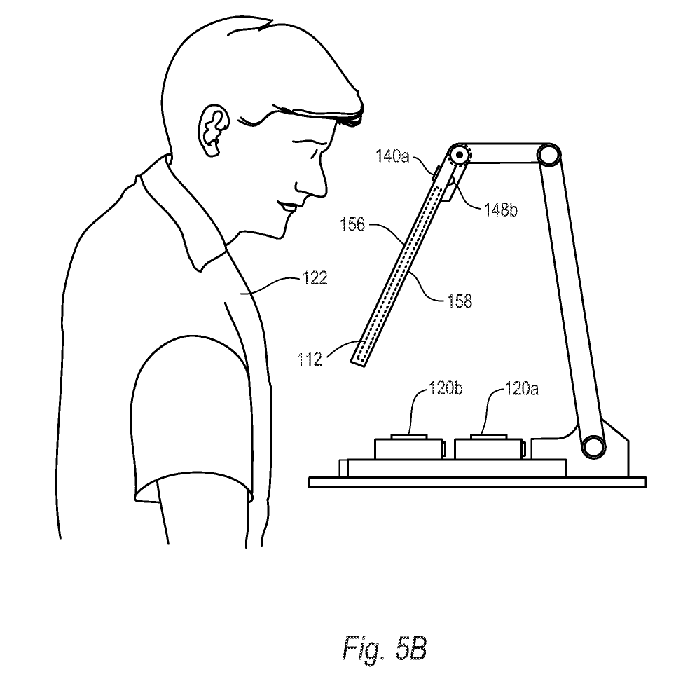

In one example of the invention, the modified image displayed does not create displayed content based on sensed values of the user's viewpoint. However, as shown in FIG. 4C and FIG. 5A for example—there may be a spatial relationship between the user interface displayed and the objects they correspond to. However, the spatial relationship may not stay consistent as the user moves their head and/or the object behind the display screen. For example, referring to FIG. 5A shows a front perspective view of a desktop version of the display system shown in FIG. 1 where two cameras are positioned behind the display screen. In one example of the invention, the position of the menus 510a and 510b with respect to the cameras 120a and 120b behind the screen changes as the user changes their viewpoint.

Referring to FIG. 5A and FIG. 5B shows a front and side perspective view respectively of two cameras positioned behind the thru-screen display when operating in a transparent mode of operation. In this example, the user's view of the displayed menu is not viewpoint dependent, however the displayed menu is spatially aligned with the displayed content. For the example shown, the spatial arrangement of the two menus that appear roughly mirror the spatial arrangement of the cameras viewed through the screen. Thus the menu 510a displayed on the display screen is associated with the camera 120a and the menu 510b displayed on the display screen is associated with the camera 510b.

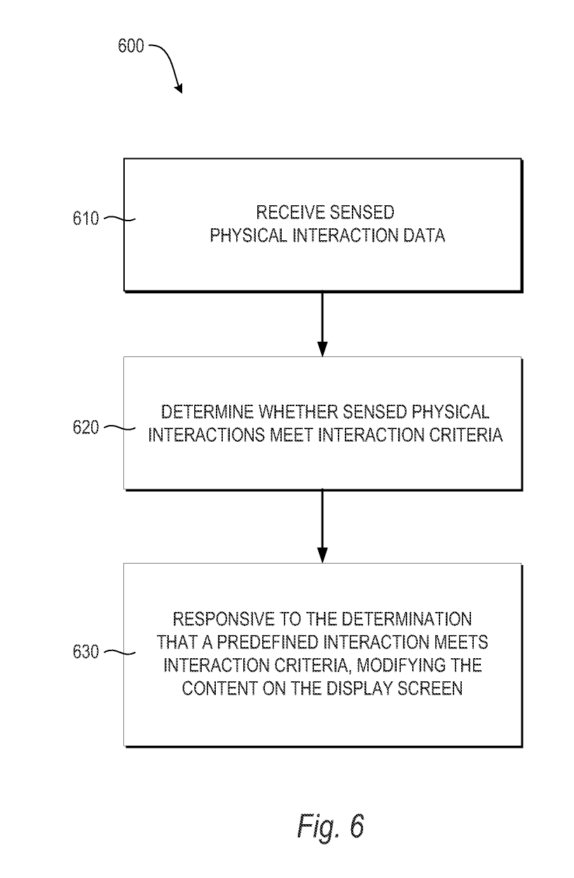

FIG. 6 shows a flow diagram for a method of displaying content for augmenting the display of an interfacing device positioned behind a transparent display screen according to an example of the invention. Specifically, FIG. 6 shows the method 600 of generating content responsive to whether an interaction has occurred. The steps include: receiving sensed physical interaction data (step 610); determining whether the sensed physical interactions meet the interaction criteria (step 620); and responsive to the determination that a the sensed physical interaction meets the interaction criteria, modifying the content on the display screen (630).

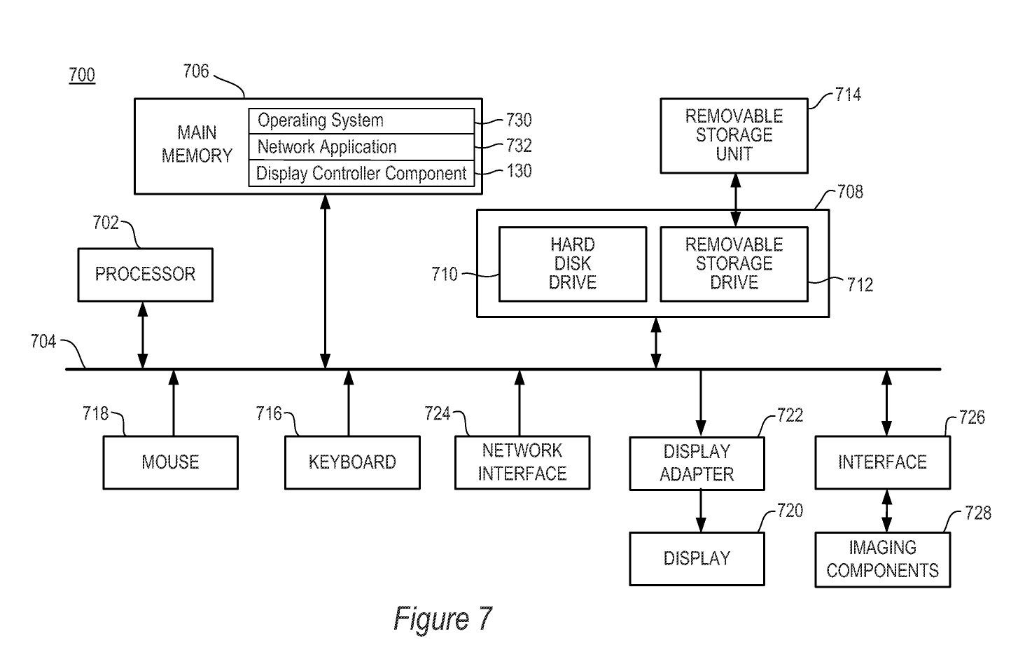

FIG. 7 shows a computer system for implementing the methods shown in FIG. 6 and described in accordance with embodiments of the present invention. It should be apparent to those of ordinary skill in the art that the method 600 represents generalized illustrations and that other steps may be added or existing steps may be removed, modified or rearranged without departing from the scopes of the method 600. The descriptions of the method 600 are made with reference to the system 100 illustrated in FIG. 1 and the system 700 illustrated in FIG. 7 and thus refers to the elements cited therein. It should, however, be understood that the method 600 is not limited to the elements set forth in the system 700. Instead, it should be understood that the method 600 may be practiced by a system having a different configuration than that set forth in the system 700.

Some or all of the operations set forth in the method 600 may be contained as utilities, programs or subprograms, in any desired computer accessible medium. In addition, the method 600 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

FIG. 7 illustrates a block diagram of a computing apparatus 700 configured to implement or execute the methods 600 depicted in FIG. 6, according to an example. In this respect, the computing apparatus 700 may be used as a platform for executing one or more of the functions described hereinabove with respect to the display controller component 130.

The computing apparatus 700 includes one or more processor(s) 702 that may implement or execute some or all of the steps described in the method 600. Commands and data from the processor 702 are communicated over a communication bus 704. The computing apparatus 700 also includes a main memory 706, such as a random access memory (RAM), where the program code for the processor 702, may be executed during runtime, and a secondary memory 708. The secondary memory 708 includes, for example, one or more hard drives 710 and/or a removable storage drive 712, representing a removable flash memory card, etc., where a copy of the program code for the method 700 may be stored. The removable storage drive 712 reads from and/or writes to a removable storage unit 714 in a well-known manner.

These methods, functions and other steps described may be embodied as machine readable instructions stored on one or more computer readable mediums, which may be non-transitory. Exemplary non-transitory computer readable storage devices that may be used to implement the present invention include but are not limited to conventional computer system RAM, ROM, EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any interfacing device and/or system capable of executing the functions of the above-described examples are encompassed by the present invention.

Although shown stored on main memory 706, any of the memory components described 706, 708, 714 may also store an operating system 730, such as Mac OS, MS Windows, Unix, or Linux; network applications 732; and a display controller component 130. The operating system 730 may be multi-participant, multiprocessing, multitasking, multithreading, real-time and the like. The operating system 730 may also perform basic tasks such as recognizing input from input devices, such as a keyboard or a keypad; sending output to the display 720; controlling peripheral devices, such as disk drives, printers, image capture device; and managing traffic on the one or more buses 704. The network applications 732 includes various components for establishing and maintaining network connections, such as software for implementing communication protocols including TCP/IP, HTTP, Ethernet, USB, and FireWire.

The computing apparatus 700 may also include an input devices 716, such as a keyboard, a keypad, functional keys, etc., a pointing device, such as a tracking ball, cursors, mouse 718, etc., and a display(s) 720, such as the screen display 110 shown for example in FIGS. 1-5. A display adaptor 722 may interface with the communication bus 704 and the display 720 and may receive display data from the processor 702 and convert the display data into display commands for the display 720.

The processor(s) 702 may communicate over a network, for instance, a cellular network, the Internet, LAN, etc., through one or more network interfaces 724 such as a Local Area Network LAN, a wireless 702.11x LAN, a 3G mobile WAN or a WiMax WAN. In addition, an interface 726 may be used to receive an image or sequence of images from imaging components 728 such as the image capture device.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A display system comprising:
A display including a display screen configured to operate in at least a transparent display mode;
an interaction sensing component for receiving sensed data regarding physical user interactions; and
An interaction display control component, wherein responsive to the sensed data meeting predefined interaction criteria, content on the display screen is modified.

2. The display system recited in claim 1 wherein the changes in the display content occur when the display screen is powered on.

3. The display system recited in claim 1 wherein the predefined interaction is the movement of the display screen from one position to another.

4. The display system recited in claim 1 wherein the predefined interaction is the movement of an object behind the display screen.

5. The display system recited in claim 1 wherein the predefined interaction is the sensing of the presence of an object positioned behind the display screen.

6. The display system recited in claim 1 wherein the predefined interaction is a touch on the display screen surface.

7. The display system recited in claim 1 wherein the modification of the display screen is the appearance of a user interface.

8. The display system recited in claim 1 wherein the user interface is a virtual representation of an object previously positioned behind the display screen.

9. A non-transitory computer readable storage medium having computer readable program instructions stored thereon for causing a computer system to perform instructions, the instructions comprising the steps of:
for a display system including a display configured to operate in at least a transparent mode of operation, determining whether sensed physical interactions meet the interaction criteria; and
responsive to the determination that a predetermined interaction meets the predefined interaction criteria, modifying the content on the display screen.

10. The computer readable medium recited in claim 9 further including the step of receiving information regarding sensing physical user interactions.

11. The computer readable medium recited in claim 9 wherein the changes in the display content occur when the display screen is powered on.

12. The computer readable medium recited in claim 9 wherein the predefined interaction is the movement of the display screen from one position to another.

13. The computer readable medium recited in claim 9 wherein the predefined interaction is the movement of an object behind the display screen.

14. The computer readable medium recited in claim 9 wherein the predefined interaction is the sensing of the presence of an object positioned behind the display screen.

15. The computer readable medium recited in claim 9 wherein the predefined interaction is a touch on the display screen surface.

16. The computer readable medium recited in claim 9 wherein the modification of the display screen is the appearance of a user interface.

17. The computer readable medium recited in claim 9 wherein the user interface is a virtual representation of an object previously positioned behind the display screen.

18. The computer readable, medium recited in claim 9 wherein the user interface is a menu spatially aligned an object positioned behind the display screen.

19. A method of modifying display content comprising the steps of:
for a display system including a display configured to operate in at least a transparent mode of operation, determining whether sensed physical interactions meet the interaction criteria; and
responsive to the determination that a predetermined interaction meets the predefined interaction criteria, modifying the content on the display screen.

20. The method recited in claim 19 further including the step of receiving information regarding sensing physical user interactions.
